(19) United States
(12) Patent Application Publication
(10) Pub. No.: US 2013/0067749 A1
(43) Pub. Date: Mar. 21, 2013

(54) POWER CABLE

(71) Applicant: Tien-Cheng Cheng, New Taipei City (TW)

(72) Inventor: Tien-Cheng Cheng, New Taipei City (TW)

(73) Assignee: H.R. SILVINE ELECTRONICS INC., New Taipei City (TW)

(21) Appl. No.: 13/233,435

(22) Filed: Sep. 15, 2011

(51) Int. Cl. B26B 19/28; H02M 7/00; H01B 9/04

(52) U.S. Cl. 30/42; 174/107; 363/125

(57) ABSTRACT

A power cable includes: a conductor layer including an inner conductor core, and an outer conductor core that surrounds the inner conductor core and that is made of copper-clad aluminum; an insulator layer that covers the conductor layer; and an outer sheath layer that covers the insulator layer.

### BACKGROUND OF THE INVENTION

1. Field of the Invention

The present invention relates to a power cable, more particularly to a power cable including copper-clad aluminum wires.

2. Description of the Related Art

Copper-based power cables are utilized in various electrical appliances and electronic devices. However, in recent years, the price of copper has increased dramatically, which contributes significantly to the generally high production costs of the electrical appliances and the electronic devices.

Considering the price of copper, other electrically conductive materials may be used in place of copper. However, electrically conductive materials that are relatively affordable generally have lower electrical conductivities, and hence may have adverse influence on performances of the electrical appliances and the electronic devices. In addition, power cables made of electrically conductive materials with relatively poor extensibilities and flexibilities are likely to fail a cable-twist test. Even if the power cables pass the cable-twist test, resistance of the electrically conductive materials in the power cables may increase significantly during use or after long-term use, which may in turn result in failure of the electrical appliances and the electronic devices.

### SUMMARY OF THE INVENTION

Therefore, an object of the present invention is to provide a power cable capable of alleviating the aforesaid drawbacks of the prior art.

Accordingly, a power cable of the present invention includes: a conductor layer including an inner conductor core, and an outer conductor core that surrounds the inner conductor core and that is made of copper-clad aluminum; an insulator layer that covers the conductor layer; and an outer sheath layer that covers the insulator layer.

Another object of the present invention is to provide a power conversion device.

Accordingly, a power conversion device of the present invention includes: an input terminal for receiving an alternating-current (AC) power signal; a power converting circuit coupled electrically to the input terminal for receiving the AC power signal therefrom, and operable to generate a direct-current (DC) power signal from the AC power signal received thereby; a power cable connected electrically to the power converting circuit for receiving the DC power signal therefrom; and an output terminal connected electrically to the power cable for providing the DC power signal received from the power cable therethrough.

The power cable includes a conductor layer including an inner conductor core, and an outer conductor core that surrounds the inner conductor core and that is made of copper-clad aluminum, an insulator layer that covers the conductor layer, and an outer sheath layer that covers the insulator layer.

Yet another object of the present invention is to provide an electric razor.

Accordingly, an electric razor of the present invention includes: a power conversion device including an input terminal for receiving an alternating-current (AC) power signal, a power converting circuit coupled electrically to the input terminal for receiving the AC power signal therefrom, and operable to generate a direct-current (DC) power signal from the AC power signal received thereby, a power cable connected electrically to the power converting circuit for receiving the DC power signal therefrom, and an output terminal connected electrically to the power cable for providing the DC power signal received from the power cable therethrough, the power cable including a conductor layer, an insulator layer that covers the conductor layer, and an outer sheath layer that covers the insulator layer, the conductor layer including an inner conductor core, and an outer conductor core that surrounds the inner conductor core and that is made of copper-clad aluminum; and a blade driving module including a blade driving unit adapted for driving movement of a razor blade, and a power switch unit connected electrically to the output terminal for receiving the DC power signal therefrom, further connected electrically to the blade driving unit, and user-operable to provide the DC power signal received from the output terminal to the blade driving unit to thereby enable operation of the blade driving unit.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of the preferred embodiment of an electric razor according to the present invention;

FIG. 2 is a block diagram of the electric razor, the electric razor being powered by a power source;

FIG. 3 is a fragmentary perspective view of a power cable of the electric razor;

FIG. 4 is a schematic diagram to show a cross-section of the power cable;

FIG. 5 is an enlarged schematic diagram to show a conductor layer of the power cable;

FIG. 6 is a fragmentary perspective view of a modified power cable of the electric razor, according to the present invention;

FIG. 7 is a schematic diagram to show a cross-section of the modified power cable; and

FIG. 8 is an enlarged schematic diagram to show a conductor layer of the modified power cable.

### DETAILED DESCRIPTION OF THE PREFERRED EMBODIMENT

Before the present invention is described in greater detail, it should be noted that like elements are denoted by the same reference numerals throughout the disclosure.

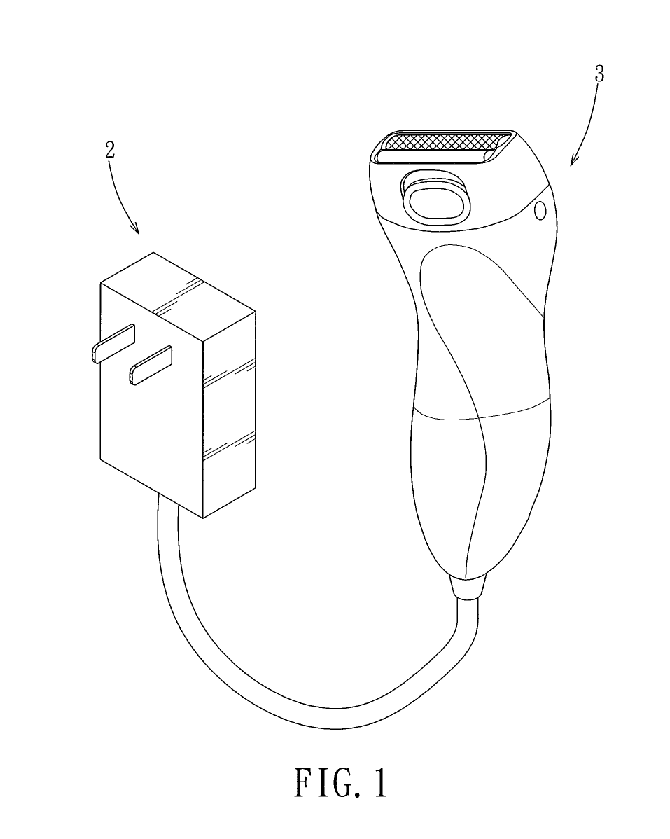

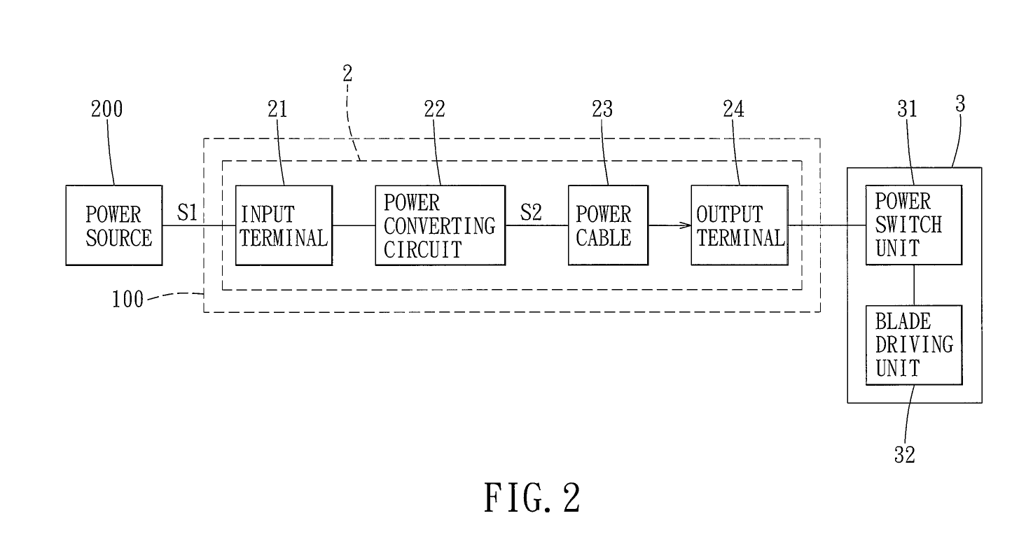

Referring to FIGS. 1 and 2, the preferred embodiment of an electric razor 100 according to this invention is adapted to receive an alternating-current (AC) power signal S1 from a power source 200, which, in this embodiment, is a residential power grid. In this embodiment, the electric razor 100 includes a power conversion device 2 and a blade driving module 3.

The power conversion device 2 is a power adaptor including an input terminal 21, a power converting circuit 22, a power cable 23, and an output terminal 24.

The input terminal 21 is adapted for connecting to the power source 200 to receive the AC power signal S1 therefrom.

The power converting circuit 22 is coupled electrically to the input terminal 21 for receiving the AC power signal 51 therefrom, and is operable to generate a direct-current (DC) power signal S2 from the AC power signal S1 received thereby. It should be noted that the power conversion device 2 is not limited to such, and may be otherwise in other embodiments.

The power cable 23 is connected electrically to the power converting circuit 22 for receiving the DC power signal therefrom.

The output terminal 24 is connected electrically to the power cable 23 for providing the DC power signal received from the power cable 23 therethrough.

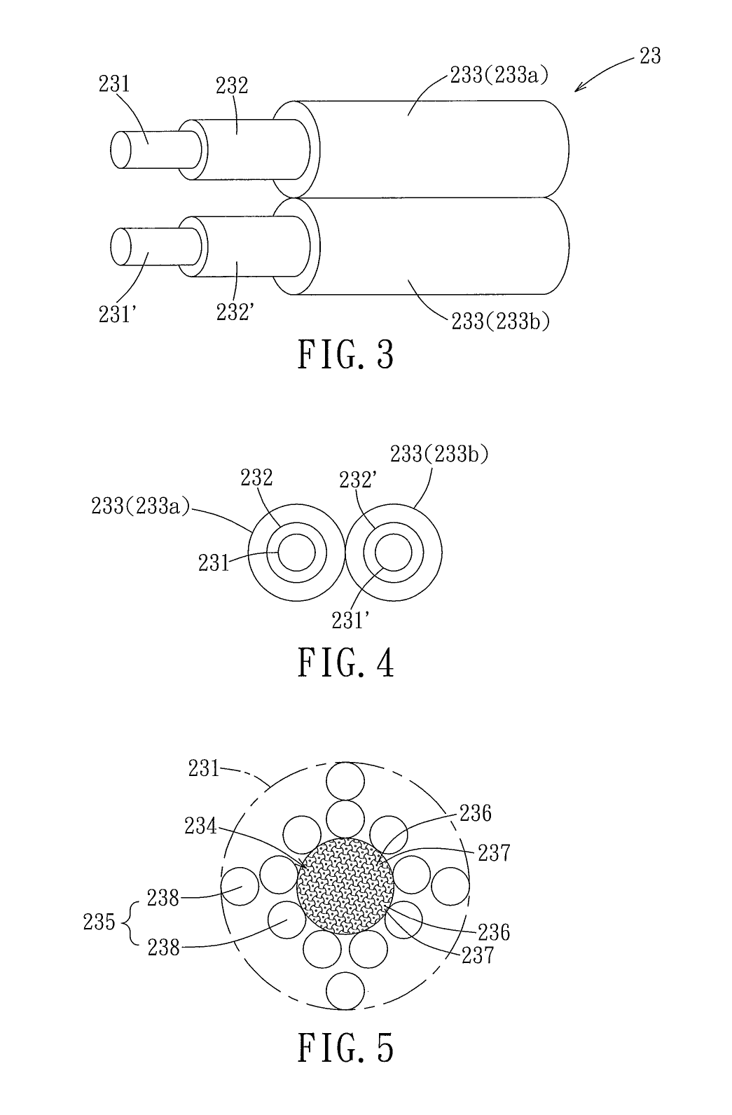

Referring to FIGS. 3 to 5, the power cable 23 includes a first conductor layer 231, a first insulator layer 232 that covers the first conductor layer 231, and an outer sheath layer 233 that covers the first insulator layer 232.

The first conductor layer 231 includes an inner conductor core 234, and an outer conductor core 235 that surrounds the inner conductor core 234 and that is made of copper-clad aluminum. The inner conductor core 234 has a plurality of fiber strands 236 and a plurality of copper foils 237 that are interwined. The outer conductor core 235 includes a plurality of copper-clad aluminum wires 238 that surround the inner conductor core 234 in a concentrically stranded manner.

The first insulator layer 232 and the outer sheath layer 233 are independently made of a material selected from polyvinylchloride (PVC), polyurethane (PU), polyethylene (PE), and polypropylene (PP).

In this embodiment, the power cable 23 further includes a second conductor layer 231′ and a second insulator layer 232′ that extend parallel to the first conductor layer 231 and the first insulator layer 232 and that are identical in configuration thereto, respectively. The outer sheath layer 233 is formed with interconnected first and second portions 233a, 233b through injection molding to cover the first and second insulator layers 232, 232′, respectively.

In this embodiment, the power cable 23 conforms to the specification of No. 24 AWG of American Wire Gauge system and has a length of 2 m. The conductor layer 231, 231′ has a diameter of 0.95 mm. The insulator layer 232, 232′ has an outer diameter of 1.3 mm. Each of the first and second portions 233a, 233b of the outer sheath layer 233 has an outer diameter of 2.2 mm. Axial lines along which the first and second conductor layers 231, 231′ respectively extend are spaced apart from each other by 2.2 mm, such that the power cable 23 has a total width of 4.4 mm. Every meter of the conductor layer 231, 231′ preferably contains 2.2 g of copper. Configuration of the power cable 23 is not limited to such.

As shown in FIG. 2, the blade driving module 3 includes a power switch unit 31, and a blade driving unit 32 that is connected electrically to the power switch unit 31 and that is adapted for driving movement of a razor blade.

The power switch unit 31 is connected electrically to the output terminal 24 for receiving the DC power signal S2 therefrom, and is user-operable to provide the DC power signal S2 received from the output terminal to the blade driving unit 32 to thereby enable operation of the blade driving unit 32.

In this embodiment, the outer conductor core 235 is a copper-clad aluminum conductor containing 15% of copper. Such a design may reduce material-related production costs by more than 30%, and may withstand a current of 400 mA under a direct-current voltage of 12V.

The fiber strands 236 of the inner conductor core 234 are made of polyester material, which has high flexibility and durability, and may withstand 360-degree twist for more than 5000 times. The insulator layer 232, 232′ is preferably made of a PU material, which ensures that the power cable 23 has relatively high flexibility to withstand twisting. The outer sheath layer 233 is preferably made of a PVC material, which not only has relatively low cost but is also suitable for integral injection molding with a connector (not shown).

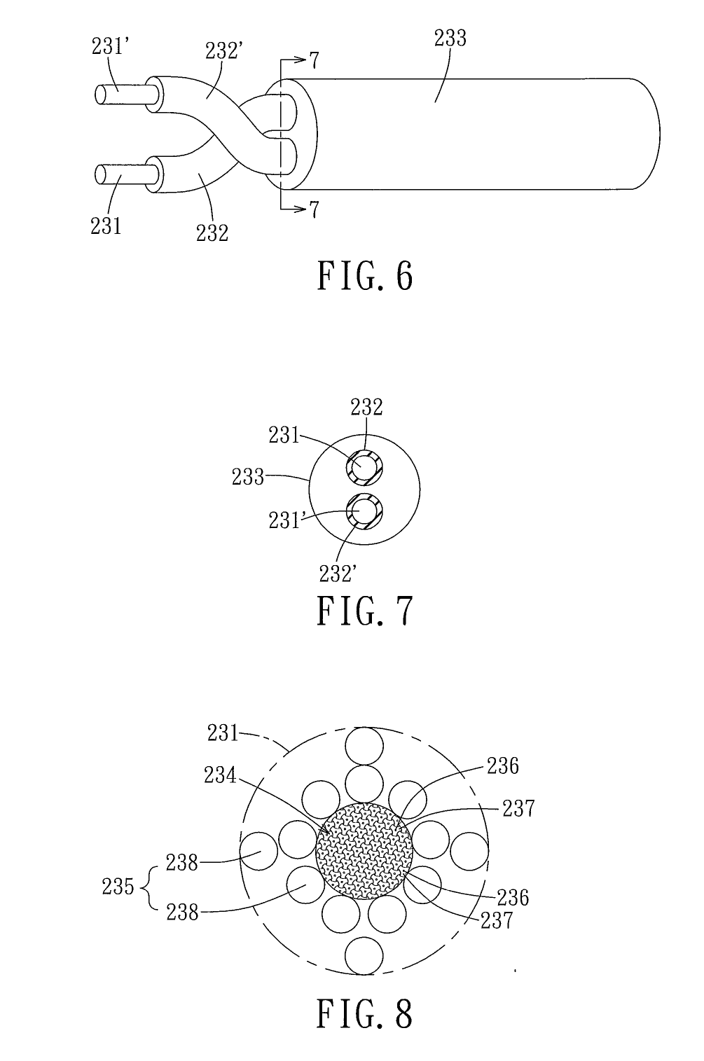

Referring to FIGS. 6 to 8, in a modification of the preferred embodiment, the first and second insulator layers 232, 232′ are twisted together, and the outer sheath layer 233 is formed to cover the first and second insulator layers 232, 232′ through injection molding. The modified power cable 23 conforms to the specification of No. 26 AWG of American Wire Gauge system and has a length of 2 m. The conductor layers 231, 231′ have a twist pitch of 0.55 mm. The insulator layer 232, 232′ has an outer diameter of 1 mm, and the outer sheath layer 233 has an outer diameter of 2.8 mm. Axial lines along which the first and second conductor layers 231, 231′ respectively extend are spaced apart from each other by 1 mm. The modified power cable 23 has a width of 2.8 mm. Every meter of the conductor layer 231, 231′ preferably contains 2.08 g of copper.

In summary, by virtue of the copper-clad aluminum structure of the outer conductor core 235 and the PVC structure of the outer sheath layer 233, the power cable 23 has a relatively low production cost and relatively good electrical characteristics. Furthermore, since the fiber strands 236 are made of polyester and the insulator layer 232, 232′ is made of PU material, the power cable 23 is able to exhibit good flexibility and resilience.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A power cable comprising:
a conductor layer including an inner conductor core, and an outer conductor core that surrounds said inner conductor core and that is made of copper-clad aluminum;
an insulator layer that covers said conductor layer; and
an outer sheath layer that covers said insulator layer.

2. The power cable as claimed in claim 1, wherein said inner conductor core has a plurality of fiber strands and a plurality of copper foils that are intertwined.

3. The power cable as claimed in claim 2, wherein said fiber strands are made of polyester material.

4. The power cable as claimed in claim 1, wherein said outer conductor core includes a plurality of copper-clad aluminum wires that surround said inner conductor core in a concentrically stranded manner.

5. The power cable as claimed in claim 1, wherein said insulator layer and said outer sheath layer are independently made of a material selected from polyvinylchloride (PVC), polyurethane (PU), polyethylene (PE), and polypropylene (PP).

6. The power cable as claimed in claim 1, comprising:
a pair of said conductor layers; and
a pair of said insulator layers covering said conductor layers, respectively;
wherein said conductor layers are arranged parallel to one another, and said outer sheath layer is formed to cover said insulator layers through injection molding.

7. The power cable as claimed in claim 1, comprising:
a pair of said conductor layers; and
a pair of said insulator layers covering said conductor layers, respectively;
wherein said insulator layers are twisted together, and said outer sheath layer is formed to cover said insulator layers through injection molding.

8. A power conversion device comprising:
an input terminal for receiving an alternating-current (AC) power signal;
a power converting circuit coupled electrically to said input terminal for receiving the AC power signal therefrom, and operable to generate a direct-current (DC) power signal from the AC power signal received thereby;
a power cable connected electrically to said power converting circuit for receiving the DC power signal therefrom; and
an output terminal connected electrically to said power cable for providing the DC power signal received from said power cable therethrough;
wherein said power cable includes
a conductor layer including an inner conductor core, and an outer conductor core that surrounds said inner conductor core and that is made of copper-clad aluminum,
an insulator layer that covers said conductor layer, and
an outer sheath layer that covers said insulator layer.

9. The power conversion device as claimed in claim 8, wherein said inner conductor core has a plurality of fiber strands and a plurality of copper foils that are intertwined.

10. The power conversion device as claimed in claim 9, wherein said fiber strands are made of polyester material.

11. The power conversion device as claimed in claim 8, wherein said outer conductor core includes a plurality of copper-clad aluminum wires that surround said inner conductor core in a concentrically stranded manner.

12. The power conversion device as claimed in claim 8, wherein said insulator layer and said outer sheath layer are independently made of a material selected from polyvinylchloride (PVC), polyurethane (PU), polyethylene (PE), and polypropylene (PP).

13. The power conversion device as claimed in claim 8, wherein said power cable includes:
a pair of said conductor layers; and
a pair of said insulator layers covering said conductor layers, respectively;
wherein said conductor layers are arranged parallel to one another, and said outer sheath layer is formed to cover said insulator layers through injection molding.

14. The power conversion device as claimed in claim 8, wherein said power cable includes:
a pair of said conductor layers; and
a pair of said insulator layers covering said conductor layers, respectively;
wherein said insulator layers are twisted together, and said outer sheath layer is formed to cover said insulator layers through injection molding.

15. An electric razor comprising:
a power conversion device including an input terminal for receiving an alternating-current (AC) power signal, a power converting circuit coupled electrically to said input terminal for receiving the AC power signal therefrom, and operable to generate a direct-current (DC) power signal from the AC power signal received thereby, a power cable connected electrically to said power converting circuit for receiving the DC power signal therefrom, and an output terminal connected electrically to said power cable for providing the DC power signal received from said power cable therethrough, said power cable including a conductor layer, an insulator layer that covers said conductor layer, and an outer sheath layer that covers said insulator layer, said conductor layer including an inner conductor core, and an outer conductor core that surrounds said inner conductor core and that is made of copper-clad aluminum; and
a blade driving module including
a blade driving unit adapted for driving movement of a razor blade, and
a power switch unit connected electrically to said output terminal for receiving the DC power signal therefrom, further connected electrically to said blade driving unit, and user-operable to provide the DC power signal received from said output terminal to said blade driving unit to thereby enable operation of said blade driving unit.

16. The electric razor as claimed in claim 15, wherein said inner conductor core has a plurality of fiber strands and a plurality of copper foils that are intertwined.

17. The electric razor as claimed in claim 16, wherein said fiber strands are made of polyester material.

18. The electric razor as claimed in claim 15, wherein said outer conductor core includes a plurality of copper-clad aluminum wires that surround said inner conductor core in a concentrically stranded manner.

19. The electric razor as claimed in claim 15, wherein said insulator layer and said outer sheath layer are independently made of a material selected from polyvinylchloride (PVC), polyurethane (PU), polyethylene (PE), and polypropylene (PP).

20. The electric razor as claimed in claim 15, wherein said power cable includes:
a pair of said conductor layers; and
a pair of said insulator layers covering said conductor layers, respectively;
wherein said conductor layers are arranged parallel to one another, and said outer sheath layer is formed to cover said insulator layers through injection molding.

21. The electric razor as claimed in claim 15, wherein said power cable includes:
a pair of said conductor layers; and
a pair of said insulator layers covering said conductor layers, respectively;
wherein said insulator layers are twisted together, and said outer sheath layer is formed to cover said insulator layers through injection molding.
